(19) United States
(12) Patent Application Publication
(10) Pub. No.: US 2006/0050856 A1
(43) Pub. Date: Mar. 9, 2006

(54) Computer telephony server for scripted call termination

(76) Inventors: Jeffrey Wayne Pence, Fullerton, CA (US); Alexander Dorfman, Irvine, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/218,815

(22) Filed: Sep. 2, 2005

Related U.S. Application Data
(60) Provisional application No. 60/606,975, filed on Sep. 3, 2004.

(51) Int. Cl. H04M 11/00

(52) U.S. Cl. 379/93.09; 379/93.01

(57) ABSTRACT

A computer telephony system includes a telephone switch to terminate a telephone set and an endpoint and to provide a trigger event associated with the telephone set, and a telephony server coupled to the telephone switch. The telephony server includes a processor, a memory coupled to the processor, and an interface coupled to the processor and to the telephone switch. The interface provides the trigger event to the processor. A script execution engine is stored in the memory and executed by the processor to cause the computer telephony server to receive the trigger event from the telephone switch, select one of a plurality of event scripts responsive to the trigger event and a directory number of the associated telephone set, execute the selected event script, and provide a command to the telephone switch as directed by the event script, the command controlling a call processing behavior of the telephone switch.

### CROSS REFERENCE TO RELATED APPLICATIONS

This application claims priority from provisional application 60/606,975, filed Sep. 3, 2004, and which is incorporated by reference.

### BACKGROUND OF THE INVENTION

A telephone switch terminates telephonic devices. In the field of telephony, terminating a device means establishing the device as an endpoint of a telephonic connection. For example, a private branch exchange (PBX) is a telephone switch that connects one terminal device, such as a telephone handset, to another terminal device, which may be a local terminal device directly connected to the telephone switch or a remote terminal device connected by a telephone network. Other examples of telephone switches are key telephone system switches and public switched telephone network (PSTN) switches.

A computer telephony server (CT server) is a computing device that may be connected to a telephone switch to provide various value-added features, such as automated attendants, voice mail, and other call handling features, for telephone calls handled by the switch. A CT server may be a specialized device, a general purpose computer, or a distributed group of server devices.

A CT server may provide call control, which is monitoring and directing calls in a telephone system. The server is able to recognize events that occur in the telephone switch, such as receipt of an incoming call, make decisions about the handling of calls based on programmed instructions, and send commands to the switch to direct the handling of calls.

A CT server may also provide telephone control, which is monitoring and controlling features of a telephone set. For example, the server may be able to recognize other events, such as key presses on terminal devices, and may be able to direct the switch to perform additional operations, such as displaying messages on terminal devices. A CT server may perform media binding to relate other communications or telephony functionality to calls in a telephone system.

The programming for a CT server may be complex with a large number of potential interactions that must be considered. This may make it difficult and time consuming to provide new value-added features. It may be infeasible to implement features that are requested by only a few users. It would be desirable if a CT server could be more easily programmed so that features could be added in response to requests from even a single user. It would be desirable if a CT server could be programmed by those with only a limited understanding of the CT server's internal structure.

### SUMMARY OF THE INVENTION

A computer telephony system includes a telephone switch to terminate a telephone set and an endpoint and to provide a trigger event associated with the telephone set, and a telephony server coupled to the telephone switch. The telephony server includes a processor, a memory coupled to the processor, and an interface coupled to the processor and to the telephone switch. The interface provides the trigger event to the processor. A script execution engine is stored in the memory and executed by the processor to cause the computer telephony server to receive the trigger event from the telephone switch, select one of a plurality of event scripts responsive to the trigger event and a directory number of the associated telephone set, execute the selected event script, and provide a command to the telephone switch as directed by the event script, the command controlling a call processing behavior of the telephone switch.

### BRIEF DESCRIPTION OF THE DRAWINGS

FIG. 1 illustrates a computer telephony system that embodies the invention.

FIG. 2 is a block diagram illustrating the hardware components of a computer telephony server that embodies the invention.

FIG. 3 illustrates a software architecture hierarchy of a computer telephony server that embodies the invention.

FIG. 4 is a block diagram illustrating the relationship between hardware components and software architecture of a computer telephony server that embodies the invention.

### DETAILED DESCRIPTION OF THE INVENTION

In the detailed description that follows, it should be appreciated that like element numerals are used to describe like elements that are illustrated in one or more of the figures.

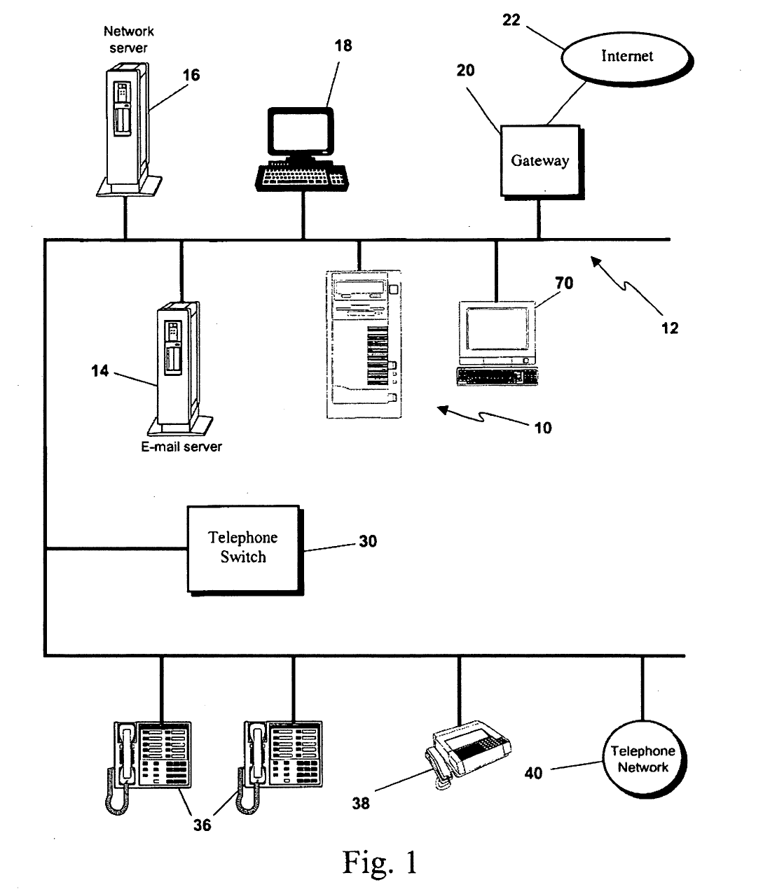

An exemplary computer telephony system that includes an embodiment of the invention will now be described with reference to FIG. 1. A computer telephony server (CT server) 10 is connected to a telephone switch 30. The telephone switch 30 may be a private branch exchange (PBX), a key telephone system, public switched telephone network or other telephone system known in the art.

The telephone switch 30 may be connected to the CT server 10 through a local area network (LAN) 12, allowing telephone switch to communicate with the CT server 10 as well as other devices connected to the LAN 12. The telephone switch may also be connected to telephone sets 36, specialized telephonic devices 38 such as a fax machine, telephone networks 40 that allow connections to remote telephonic devices, an electronic mail server 14 (e-mail server), a network server 16, a workstation 18, and a gateway 20 for providing access to a remote network 22, such as the Internet 22, which may provide a connection to remote telephonic devices. The LAN 12 may be an Ethernet network; however, other network protocols can also be utilized. It should also be appreciated by those having ordinary skill in the art that additional devices can be connected to the LAN 12, that a LAN used with embodiments of the invention may not necessarily include all of the devices illustrated in FIG. 1. Further, it will be appreciated that embodiments of the invention may replace any or all of the connections shown with direct connections rather than using a LAN.

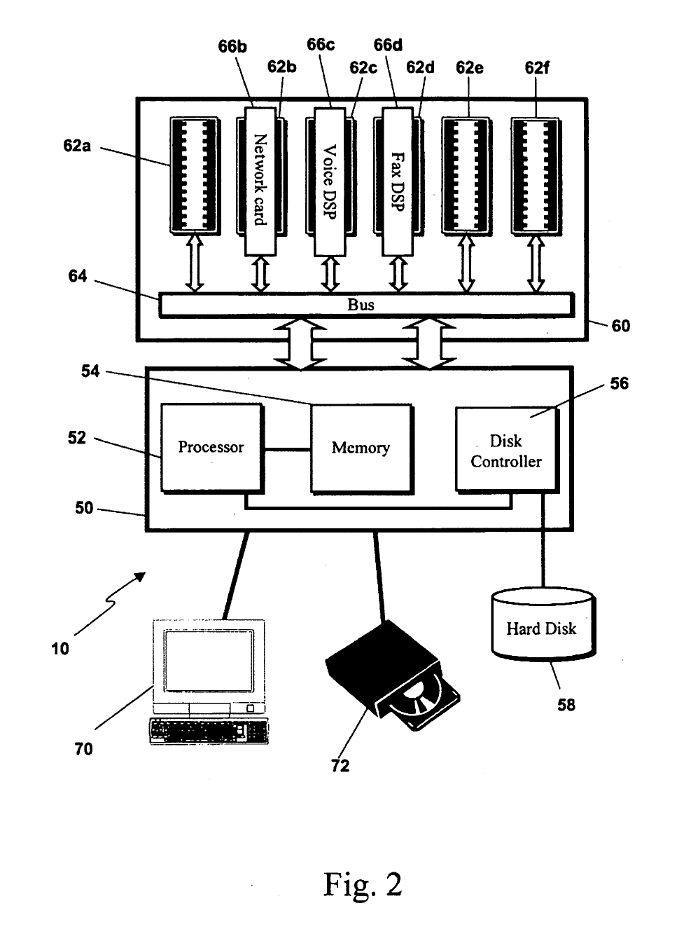

Exemplary CT server 10 hardware will now be described with reference to FIG. 2. The CT server 10 may include a processor board 50 and a backplane 60. The processor board 50 may be a Single Board Computer (SBC) which may include a processor 52, a memory 54, and a disk controller 56 which is coupled to a hard drive 58. The processor 52 may be a Pentium or Pentium compatible processor; however, other processors may also be utilized. The memory 54 may include a ROM and/or RAM. The disk controller 56 controls the hard drive 58, which may be based on an IDE interface, which may be utilized for storing data such as voice mail messages. The processor board 50 may be connected to a plurality of devices, which may include a terminal 70 to allow administration of the CT server 10, and a CD drive 72 to provide archival media for the CT server 10.

The backplane 60 may include a plurality of slots 62a-f, which are connected to a bus 64. The plurality of slots 62a-f may be Peripheral Component Interconnect (PCI) slots that are adapted to accept PCI plug-in boards such as a network card 66b for interfacing the CT server 10 with the LAN 12 which connects the telephone switch 30 and the CT server 10 among other devices, a voice digital signal processor (DSP) 66c, and a fax digital signal processor (DSP) 66d. Alternatively, the slots 62a-f may be Industry Standard Architecture (ISA) slots for connecting ISA cards, or utilize other interface standards as known in the art.

The processor board 50 is adapted to be received into a slot (not shown) on the backplane 60, thereby connecting the processor board 50 to the backplane 60. When connected, the processor board 50 communicates with the installed devices in slots 62a-62f through a bus 64. The bus 64 may be a high-speed Signal Computing bus (SCbus), which provides a 131 Mbps data path having up to 2,048 time slots, the equivalent of 1,024 two-way voice conversations at 64 Kbps. However, other bus standards may also be implemented, such as standards from the Enterprise Computer Telephony Forum (ECTF) or H.110 from the Consultative Committee on International Telephone and Telegraph (CCITT). It should be appreciated that other hardware configurations could be utilized. For example, the backplane 60 may be a passive backplane, but the CT server 10 could also be implemented with an active backplane. However, as known in the art, the utilization of passive backplanes and single board computers facilitates an open, modular hardware platform.

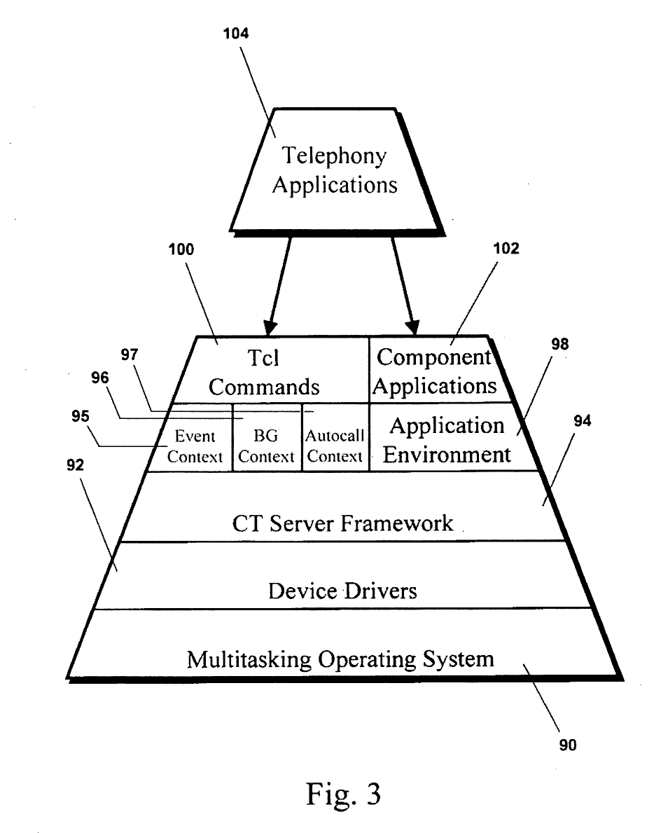

An environment to support scripts on a CT server 10 that embodies the invention will now be described with reference to FIG. 3. At the lowest level, the CT server 10 runs a multitasking operating system 90, such as Windows NT by Microsoft Corp. Windows NT is a 32-bit operating system that includes features such as peer-to-peer networking, preemptive multitasking, multithreading, multiprocessing and fault tolerance. It should be apparent that other multitasking operating systems, such as UNIX, can of course be utilized. A second level of software, running on the operating system 90, includes device drivers 92. Generally, the device drivers 92 are provided by the manufacturer of individual hardware devices and are utilized to link the hardware devices to the operating system 90.

A third level of software is a CT server framework 94. The CT server framework 94 is an event-driven, object-oriented software environment used for the development and operation of server-based CT Integration applications such as voice mail and interactive voice response (IVR) systems. The CT server framework 94 is a unique application interface and infrastructure for the development of CT server applications.

A fourth level of software includes on or more execution contexts 95, 96, 97 in which scripts may be loaded and processed. The execution contexts provide a mechanism to allow new scripted procedures to be added without requiring modifications to the main executable. As known in the art, Windows NT provides a software architecture called Component Object Model (COM) which allows applications to be built from separate binary components. In particular, COM provides a mechanism to construct and register objects dynamically, thus eliminating the need for statically linking with object code. An application environment 98 locates new objects from a registry, loads them as needed, and makes the component objects available to the scripted procedures being processed in the execution contexts 95, 96, 97.

The scripting language for the scripted procedures may be a language known in the art, such as Tool Command Language (Tcl). Tcl is an interpreted script language that is used to develop applications, and provides an interface into applications that use Tcl functions. It should be apparent that other scripting languages and interfaces can of course be utilized.

A fifth level of software includes script commands such as Tcl commands 100 and component applications 102. The Tcl commands 100 include script commands for performing basic system functions. The component applications 102 include compiled applications for performing various call processing functions.

The sixth level of software includes telephony applications 104. The telephony applications may include programmed applications such as media resources that perform CT functions such as message recording, playback of recorded messages, and interactive voice response. The telephony applications may further include scripted procedures which may use one or more script language commands 100 and/or component applications 102 to perform large scale CT applications, including call processing, and managed call termination.

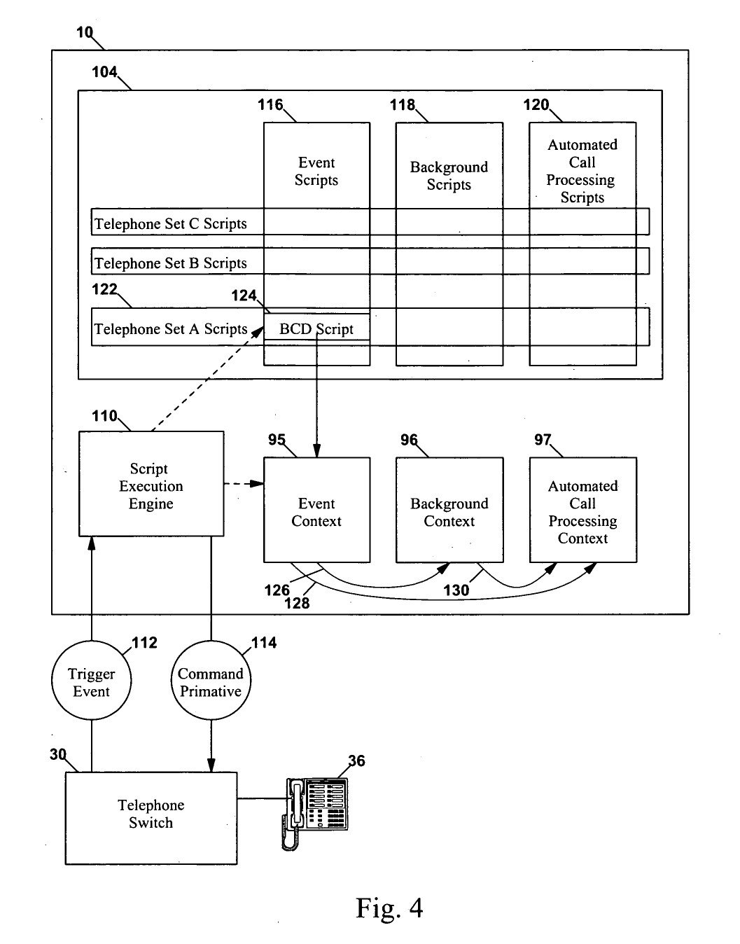

A script execution engine 110 that processes scripted procedures on the CT server 10 using the environment shown in FIG. 3 will now be described with reference to FIG. 4. The telephone switch 30 provides trigger events 112 associated with a telephone set 36 to the telephony server 10 when certain events are detected by the telephone switch. The trigger event 112 may be provided to the telephony server 10 from the telephone switch 30 through an interface such as the LAN 12.

The trigger event may be a before call delivery event, a before call clearance event, or a key press event. A before call delivery event is sent when a call has been received for termination by the telephone switch 30, a telephone device connected to the telephone switch has been identified to terminate the call, but before the call is terminated. A before call clearance event is sent when a request to tear down a connection has been received for a call terminated by the telephone switch 30, but before the connection is torn down. A key press event is sent when designated keys on a telephonic device connected to the telephone switch 30 are received by the telephone switch. The trigger events are sent to the CT server 10 which may send a command to the telephone switch to control a call processing behavior of the telephone switch. The telephone switch 30 may deliver the call or clear the call after a predetermined time has elapsed from sending the trigger event if the telephone switch has not received a command to control the call processing in response to sending the trigger event.

The trigger event may include a list of parameters that may include a prime directory number of the telephone set that is the target of the trigger event, an event number assigned to the trigger event by the telephone switch, a position of the key that was pressed, or zero if the trigger event is not related to a pressed key, a unique sequence number assigned to the trigger event by the telephone switch 30, and/or an internal event number assigned by the script execution engine that links the trigger event to the event script being processed for the event trigger. Additional parameters may be provided that are specific to particular types of trigger events. For before call delivery events the calling station or trunk, and the caller ID. For before call clearance events the parameters may include a flag to indicate whether the disconnect is being initiated by the local end or the far end.

The CT server processor 52 receives a trigger event from the telephone switch 30 through an interface 66b and causes the script execution engine 110, which is a program stored in memory 54, to be executed by the processor to handle the trigger event. The script execution engine 110 selects one of a plurality of event scripts 116 which are part of the telephony applications 104 based on the trigger event and a directory number (DN) of the telephone set 122 associated with the trigger event. The DN may be an extension number of the telephone set. As suggested by the dashed arrow from the script execution engine 110 to the before call delivery script 124, the script execution engine selects the script by choosing the script that corresponds to the trigger event from the event scripts 116 that are associated with the telephone set 122 that cause the trigger event 112.

The script execution engine 110 may use a distributor process to select an event script based on the trigger event received and the telephonic device associated with the trigger event. The distributor may look up a directory number (DN) of the phone associated with the trigger event, and identify a collection of one or more event scripts in the telephony applications 104 that are registered with that phone. The DN is the identity of a telephone set and may be the extension number. If no event script is registered with the directory number of the associated telephone set for the trigger event, the distributor may send an end transaction primitive back to the call agent, and stop processing of the event trigger.

If an event script is registered with the directory number of the associated telephone set for the trigger event, the distributor may create an event context 95 on a separate thread of execution. The event context provides the resources necessary to determine how a call should be terminated and/or direct immediate actions that can be taken with respect to the telephone set but deferred actions are not supported, there is no interaction with other scripts, and no media resources are available to provide automated calling functions. These limitations may simplify the preparation of scripted procedures with out a detailed knowledge of the CT server implementation.

The script execution engine 110 may create a script application object, which may include a script interpreter, and post the script application object to the event context, along with the event script. The script execution engine then causes the event script to be processed to completion. The event script may provide a command primitive 14 to the telephone switch 10, the command primitive controlling a call processing behavior of the telephone switch. The script execution engine 110 may receive the request to issue a command primitive to the telephone switch 10 from the event script and provide the actual communication of the command primitive 14 to the telephone switch on behalf of the event script using the LAN 12 or other communication channel between the CT server 10 and the telephone switch 30. The use of command primitives sent to the telephone switch 30 may allow the event script to override the default call processing behavior of the telephone switch for certain types of event on certain phones. For example, an inbound call directed to the associated telephone set may be terminated to an endpoint other than the associated telephone set (e.g. call forwarding).

As noted above, the event script context 95 does not support deferred actions or interaction with other scripts. The script execution engine may create a background processing context 96. The background processing context may be created in response to a request 126 from an event script or it may be created as part of the initialization of the CT server. The background script may execute on a second separate thread of execution. The event script may provide a background script to be performed in the background processing context. The background script may be provided by providing a pointer or handle that identifies the background script 118 in the telephony applications 104. The background script may have access to timers to allow the processing of commands on a scheduled basis. The background script may coordinate the performance of commands that have been requested by a number of different scripts. For example, an event script that wishes to display a message on a telephone set for a period of time may issue a request for that action to be performed by a background script. The background script may wait until the message display area of the telephone set is not in use for any other request, display the message, and then clear and release the display after the requested period of time has elapsed.

As noted above, the event script context 95 does not provide media resources as would be required to provide automated call processing functions. The script execution engine may create an automated call processing context 97 in response to a request 128 from the event script or a request 130 from the background script. The automated call processing context includes media resources that can be connected to a telephone network allowing the CT server 10 to serve as a telephonic device to terminate one end of a connection. The event script may then issue a command to the telephone switch 30 to cause the telephone switch to terminate a call to the automated call processing context 97 created by the event script. The event script may identify an automated call processing script 120 from the telephony applications 104 to be processed in the automated call processing context 97 for the call terminated to the automated call processing context by the event script. The automated call processing script may execute on a third separate thread of execution.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A computer telephony server comprising:
a processor;
a memory coupled to the processor;
an interface coupled to the processor and to a telephone switch, the interface to provide a trigger event from the telephone switch to the processor, the trigger event being associated with a telephone set connected to the telephone switch; and
a script execution engine stored in the memory and executed by the processor to cause the computer telephony server to receive the trigger event from the telephone switch, select one of a plurality of event scripts responsive to the trigger event and a directory number of the associated telephone set,
execute the selected event script, and
provide a command to the telephone switch as directed by the event script, the command controlling a call processing behavior.

2. The computer telephony server of claim 1 wherein the script execution engine is further to create an event context for the event script and execute the event script on a separate thread of execution.

3. The computer telephony server of claim 2 wherein the script execution engine is further to create a background processing context, wherein the event script further provides a background script to be performed in the background processing context, and wherein the background script executes on a second separate thread of execution.

4. The computer telephony server of claim 2 wherein the script execution engine is further to create an automated call processing context in response to a request from the event script, the automated call processing context including media resources that can be connected to a telephone network, and wherein the call processing behavior of the command provided to the telephone switch by the event script includes terminating a call to the automated call processing context.

5. The computer telephony server of claim 4 wherein the command provided to the telephone switch for terminating the call further identifies an automated call processing script to be processed in the automated call processing context for the call terminated to the automated call processing context by the event script, and wherein the automated call processing script executes on a third separate thread of execution.

6. The computer telephony server of claim 2 wherein the script execution engine is further to create a script application object that includes a script interpreter in the event context, and post the script application object to the new session with the event script to be run.

7. The computer telephony server of claim 1 wherein the script execution engine is further to stop processing for the trigger event if no event script is registered with the directory number of the associated telephone set for the trigger event.

8. The computer telephony server of claim 1 wherein the trigger event is one of a before call delivery event and a before call clearance event.

9. The computer telephony server of claim 1 wherein the call processing behavior includes terminating an inbound call directed to the associated telephone set to an endpoint other than the associated telephone set.

10. A computer telephony system comprising:
a telephone switch to terminate a telephone set and an endpoint, and to provide a provide a trigger event associated with the telephone set; and
a telephony server coupled to the telephone switch, the telephony server including
a processor,
a memory coupled to the processor,
an interface coupled to the processor and to the telephone switch, the interface to provide the trigger event to the processor, and
a script execution engine stored in the memory and executed by the processor to cause the computer telephony server to receive the trigger event from the telephone switch, select one of a plurality of event scripts responsive to the trigger event and a directory number of the associated telephone set, execute the selected event script, and provide a command to the telephone switch as directed by the event script, the command controlling a call processing behavior.

11. The computer telephony system of claim 10 wherein the script execution engine is further to create an event context for the event script and execute the event script on a separate thread of execution.

12. The computer telephony system of claim 11 wherein the script execution engine is further to create a background processing context, wherein the event script further provides a background script to be performed in the background processing context, and wherein the background script executes on a second separate thread of execution.

13. The computer telephony system of claim 12 wherein the script execution engine is further to create an automated call processing context in response to a request from the event script, the automated call processing context including media resources that can be connected to a telephone network, and wherein the call processing behavior of the command provided to the telephone switch by the event script includes terminating a call to the automated call processing context.

14. The computer telephony system of claim 13 wherein the command provided to the telephone switch for terminating the call further identifies an automated call processing script to be processed in the automated call processing context for the call terminated to the automated call processing context by the event script, and wherein the automated call processing script executes on a third separate thread of execution.

15. The computer telephony system of claim 11 wherein the script execution engine is further to create a script application object that includes a script interpreter in the event context, and post the script application object to the new session with the event script to be run.

16. The computer telephony system of claim 10 wherein the script execution engine is further to stop processing for the trigger event if no event script is registered with the directory number of the associated telephone set for the trigger event.

17. The computer telephony system of claim 10 wherein the trigger event is one of a before call delivery event and a before call clearance event.

18. The computer telephony system of claim 10 wherein the call processing behavior includes terminating an inbound call directed to the associated telephone set to an endpoint other than the associated telephone set.

19. A computer telephony server comprising:
means for receiving a trigger event from a telephone switch, the trigger event associated with a telephone set connected to the telephone switch,
means for selecting one of a plurality of scripts responsive to the trigger event and a directory number of the telephone set,
means for executing the selected script, and
means for providing a command to the telephone switch as directed by the script, the command controlling a call processing behavior for the connecting of the telephone set to the telephone network.

20. The computer telephony server of claim 19 wherein the script execution engine is further to create an event context for the event script and execute the event script on a separate thread of execution.

21. The computer telephony server of claim 20 wherein the script execution engine is further to create a background processing context, wherein the event script further provides a background script to be performed in the background processing context, and wherein the background script executes on a second separate thread of execution.

22. The computer telephony server of claim 20 wherein the script execution engine is further to create an automated call processing context in response to a request from the event script, the automated call processing context including media resources that can be connected to a telephone network, and wherein the call processing behavior of the command provided to the telephone switch by the event script includes terminating a call to the automated call processing context.

23. The computer telephony server of claim 22 wherein the command provided to the telephone switch for terminating the call further identifies an automated call processing script to be processed in the automated call processing context for the call terminated to the automated call processing context by the event script, and wherein the automated call processing script executes on a third separate thread of execution.

24. The computer telephony server of claim 20 wherein the script execution engine is further to create a script application object that includes a script interpreter in the event context, and post the script application object to the new session with the event script to be run.

25. The computer telephony server of claim 19 wherein the script execution engine is further to stop processing for the trigger event if no event script is registered with the directory number of the associated telephone set for the trigger event.

26. The computer telephony server of claim 19 wherein the trigger event is one of a before call delivery event and a before call clearance event.

27. The computer telephony server of claim 19 wherein the call processing behavior includes terminating an inbound call directed to the associated telephone set to an endpoint other than the associated telephone set.
